(19) United States
(12) Patent Application Publication
(10) Pub. No.: US 2010/0166466 A1
(43) Pub. Date: Jul. 1, 2010

(54) TONER CARTRIDGE AND IMAGE FORMING APPARATUS

(75) Inventor: Tsutomu SATO, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/633,377

(22) Filed: Dec. 8, 2009

Related U.S. Application Data
(60) Provisional application No. 61/142,075, filed on Dec. 31, 2008.

(30) Foreign Application Priority Data
Oct. 9, 2009 (JP) 2009-234876

(51) Int. Cl. G03G 15/08

(52) U.S. Cl. 399/262

(57) ABSTRACT

According to one embodiment a toner cartridge includes a case to contain toner, a rotator to rotate and stir the toner in the case round a rotary shaft line, and a clicker piece to move a space separated from the toner in the direction of the rotary shaft line.

### CROSS-REFERENCE TO RELATED APPLICATION

This application is based upon and claims the benefit of priority from U.S. provisional application 61/142,075, filed on Dec. 31, 2008, the entire contents of all of which are incorporated herein by reference.

This application is also based upon and claims the benefit of priority from Japanese Patent Application No. 2009-234876, filed on Oct. 9, 2009, the entire contents of all of which are incorporated herein by reference.

### TECHNICAL FIELD

Exemplary embodiments described herein relate to an image forming apparatus and a toner cartridge used by the same.

### BACKGROUND

If stored for a long period of time, toner in a toner cartridge is set. Japanese Patent Application Publication No. 6-348130 discloses a constitution that toner set in a toner cartridge is broken down by rotating a rotator in the toner cartridge by an image forming apparatus.

There is a limit to the breakdown of the set toner by rotating the rotator in the toner cartridge by the image forming apparatus, so that a user generally breaks down the set toner by shaking the toner cartridge before setting the toner cartridge in the image forming apparatus. Sufficient amplitude and power for shaking the toner cartridge have not been indicated mechanically and the amplitude and power may be insufficient to break down the toner by the user.

### SUMMARY

An aspect of the present disclosure relates to a toner cartridge, containing: a case to contain toner; a rotator to rotate and stir the toner in the case round a rotary shaft line; and a clicker piece to move a space separated from the toner in a direction of the rotary shaft line.

Another aspect of the present disclosure relates to an image forming apparatus, containing: a toner cartridge including: a case to contain toner; a rotator to rotate and stir the toner in the case round a rotary shaft line; and a clicker piece to move a space separated from the toner in a direction of the rotary shaft line; and an image forming unit to form an image on a sheet with the toner supplied by the toner cartridge.

### DESCRIPTION OF THE DRAWINGS

FIG. 1 is a perspective view showing the image forming apparatus;

FIG. 2 is an exploded perspective view showing the toner cartridge;

FIG. 3 is a top view showing the toner cartridge;

FIG. 4 is a cross sectional view showing the toner cartridge;

FIG. 5 is a cross sectional view showing a modification of the toner cartridge;

FIG. 6 is a cross sectional view showing a modification of the toner cartridge;

FIG. 7 is a cross sectional view showing a modification of the toner cartridge;

FIG. 8 is a cross sectional view showing a modification of the toner cartridge;

FIG. 9 is a cross sectional view showing the toner cartridge; and

FIG. 10 is an exploded perspective view showing a modification of the toner cartridge.

### DETAILED DESCRIPTION

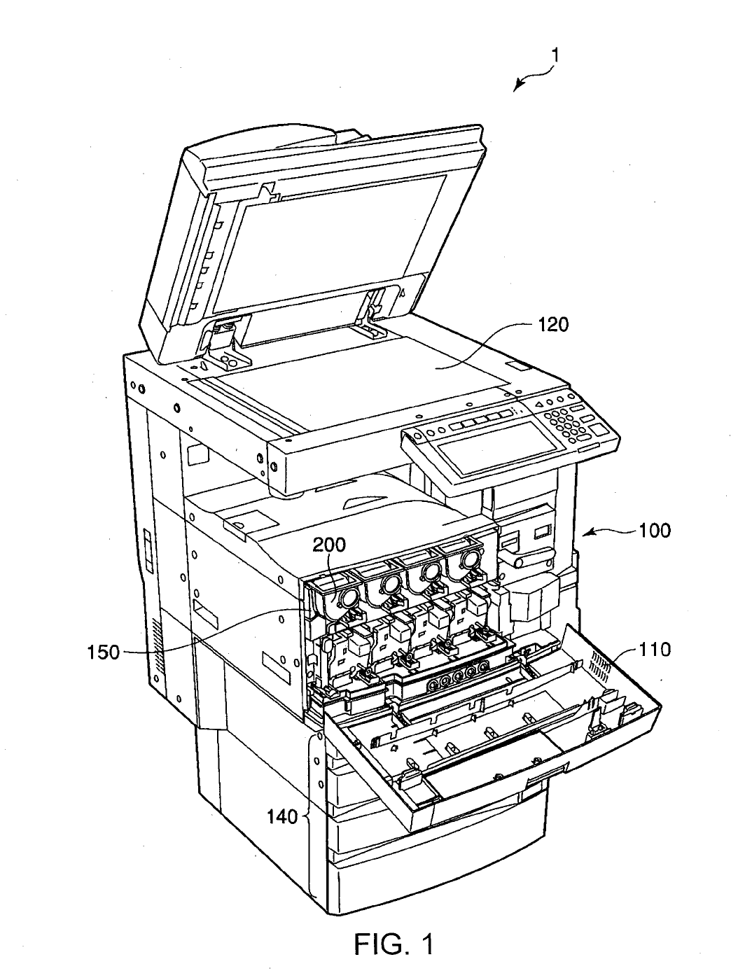

FIG. 1 is a perspective view of an image forming apparatus 1. The image forming apparatus 1 includes a printer unit 100, a scanner 120, and a sheet cassette 140.

The printer unit 100 forms an image on a sheet supply from the sheet cassette 140. The printer unit 100 has a cover 110 on the front side thereof. There is a toner cartridge 200 installed in the cover 110. The scanner 120 reads an image of a document which is an origin of the image formed on the sheet by the printer unit 100. The sheet cassette 140 stores sheets supplied to the printer unit 100.

A cartridge holder 150 supports removably the toner cartridge 200. The toner cartridge 200 supplies toner to the printer unit 100.

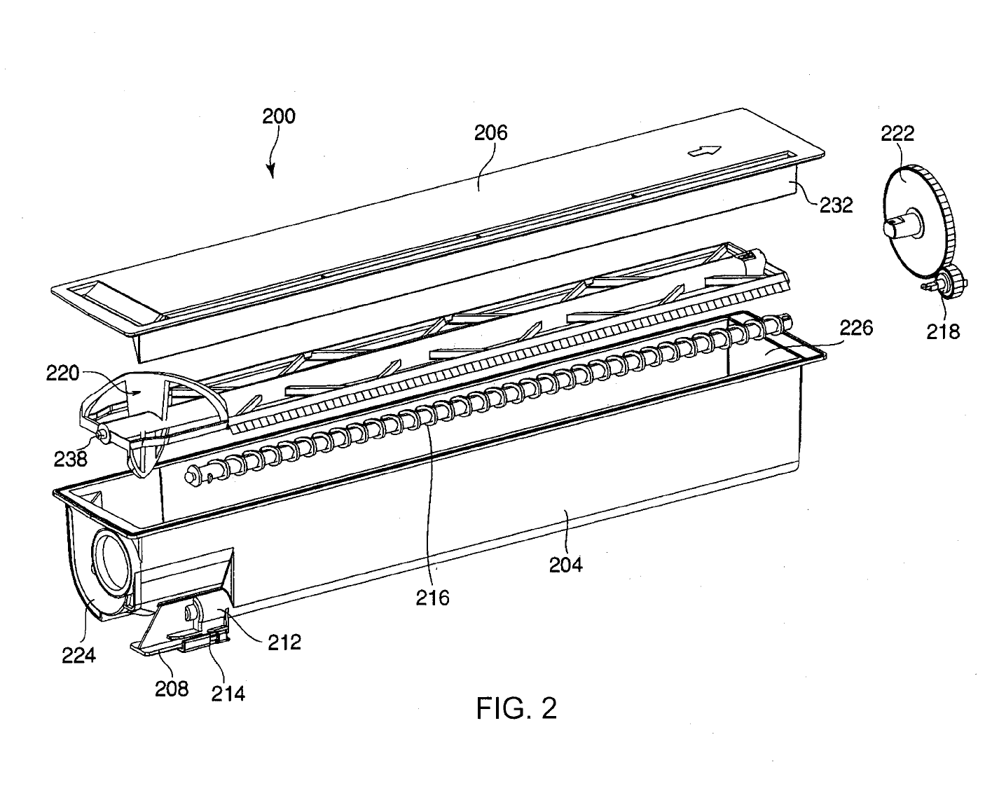

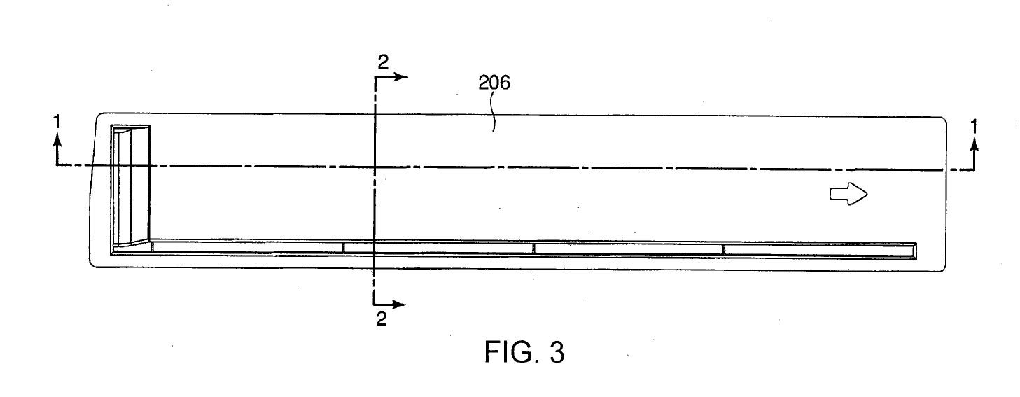

FIG. 2 is an exploded perspective view of the toner cartridge 200. FIG. 3 is a top view of the toner cartridge 200. The toner cartridge 200 includes a case 204, a lid 206, a shatter guide 208, an outlet 212, a shatter 214, a screw 216, a coupling 218, a mixer 220, a mixer gear 222, a front wall 224, a rear wall 226, a locator rib 232, an shaft end 238, and a bearing 236.

The case 204 contains toner. The case 240 has an inner bottom surface 203 in a circular arc shape continued from the front side to the rear side. The case 204 includes the front wall 224 at the front end and the rear wall 226 at the rear end. The top of the case 204 is closed by the lid 206. The outlet 212 to supply the toner in the case 204 to the printer unit 100 is installed on the right-end bottom viewed from the front side which is positioned at the front end of the case 204. The outlet 212 has a hoe through which toner is dropped to the printer unit 100 in the bottom. On the extension line of the outlet 212 in the case 204, a round slit 217 is extended from the front side to the rear side.

The shatter guide 208 is extended from the rear side to the front side. The shatter 214 slides from the rear position for closing the hole to the front position for exposing the hole along the shatter guide 208. If the toner cartridge 200 is out of the cartridge holder 150, the shatter 214 closes the hole due to the pressing force to the rear position. If the toner cartridge 200 is set in the cartridge holder 150 with the rear side positioned at the top, the shatter 214 is caught by the cartridge holder 150 and is pressed to the front position, thus the hole is exposed.

The coupling 218 passes through the right-end bottom, viewed from the front side, of the rear wall 226. The screw 216 is installed in the round slit 217. The coupling 218 is connected to the rear end of the screw 216 inside the case 204. If the coupling 218 turns the screw 216 clockwise viewed from the front side, the screw 216 conveys the toner round the screw 216 in the round slit 217 toward the outlet 212. The screw 216 may have power for stirring the toner.

The mixer 220 rotates along the inner bottom surface 203 in a circular arc shape of the case 204. The rotary shaft line of the mixer 220 is extended from the front side to the rear side. The mixer 220 stirs the toner in the case 204. The mixer gear 222 passes through the rear wall 226 on the rotary shaft line of the mixer 220. The cover rib is extended from the rear wall 226 so as to cover the peripheral surface of the mixer gear 222. The mixer gear 22 is connected to the rear end of the mixer 220 inside the case 204. The mixer gear 222 mates with the gear teeth cut on the outer periphery of the coupling 218. If the coupling 218 rotates clockwise viewed from the front side, the mixer gear 222 rotating counterclockwise viewed from the front side rotates the mixer 220 counterclockwise viewed from the front side.

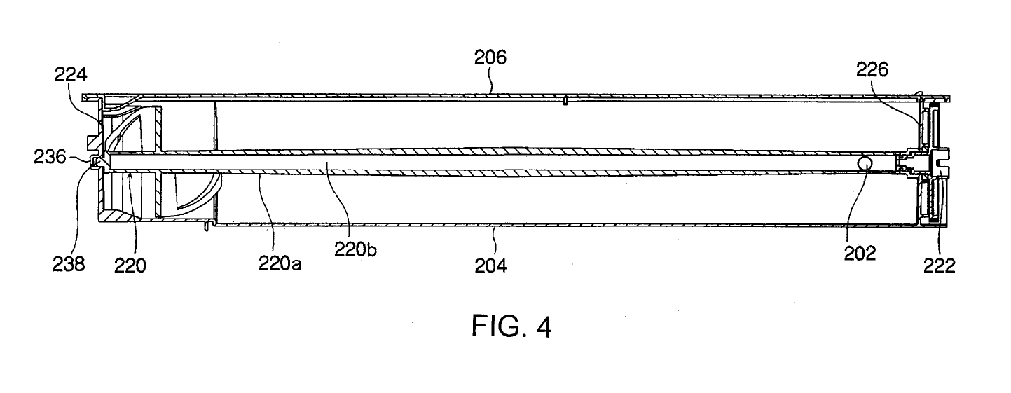

FIG. 4 is a cross sectional view of the toner cartridge 200 along the section 1-1 shown in FIG. 3. The front wall 224 has the bearing 236 on the rotary shaft line of the mixer 220. The shaft end 238 of the mixer 220 is rotatably fit into the bearing 236.

The mixer 220 has a hollow shaft 220a. A space 220b in the shaft 220a may have a diameter uniform from the front end to the rear end. The space 220b is closed at the front end by the shaft end 238. The space 220b is closed at the rear end when the mixer gear 222 is connected. The space 220b may be increased gradually in diameter from one end to the other end so as to facilitate the die cutting for molding the mixer 220.

The clicker piece 202 is installed in the space shut in the shaft 220a. The clicker piece 202 may be a sphere. The clicker piece 202 may be made of metal or resin. The clicker piece 202 can move in the space shut in the shaft 220a in the direction of the rotary shaft line of the mixer 220. If the user shakes the toner cartridge 200 rhythmically with sufficient amplitude and power in the direction of the rotary shaft line of the mixer 220 before setting the toner cartridge 200 in the cartridge holder 150, the clicker piece 202 collides with one end or the other end of the space 220b and makes a sound.

To produce a sound for letting the user shake the toner cartridge 200 with rhythm, amplitude, and power suited to break down the set toner, an advice may be made for the space shut in the shaft 220a and the clicker piece 202.

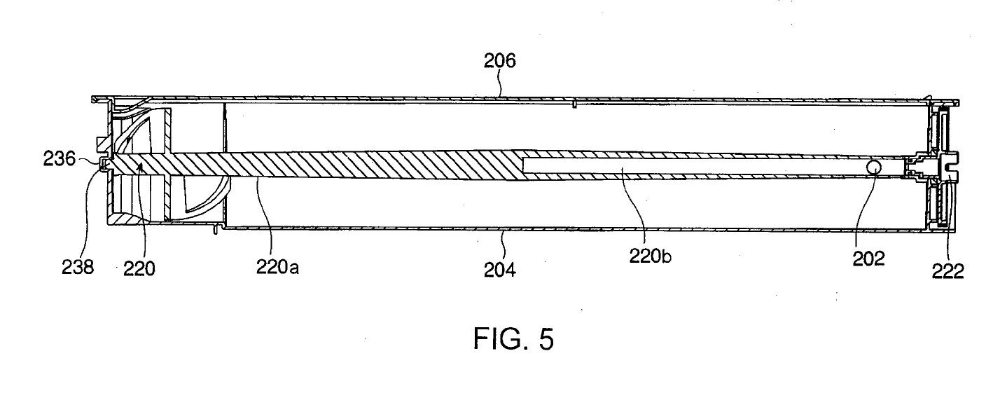

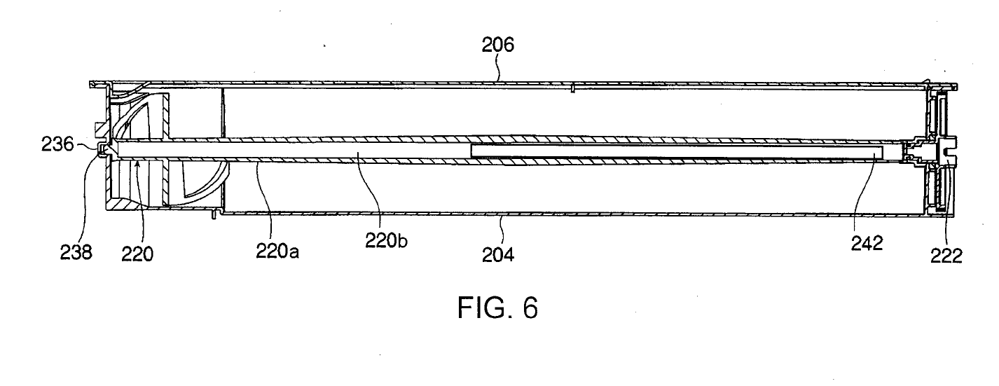

The length of the space shut in the shaft 220a in the direction of the rotary shaft line of the mixer 220 may be shorter than the total length of the mixer 220. For example, the space shut in the shaft 220a, as shown in FIG. 5, may have a length equal to or shorter than a half of the length of the mixer 220 in the direction of the rotary shaft line. The shaft 220a may be solid from one end to the middle and hollow from the middle to the other end. As shown in FIG. 6, in place of the spherical clicker piece 202, a rod which is narrower than the diameter of the space 220b and is longer than the diameter of the space 220b in the direction of the rotary shaft line of the mixer 220 may be used as a clicker piece 242. In the direction of the rotary shaft line of the mixer 220, the length of the space 220b and the length of the clicker piece 202 or the clicker piece 242 may be optimized to permit the user to shake the toner cartridge 200 with rhythm, amplitude, and power suited to break down the set toner.

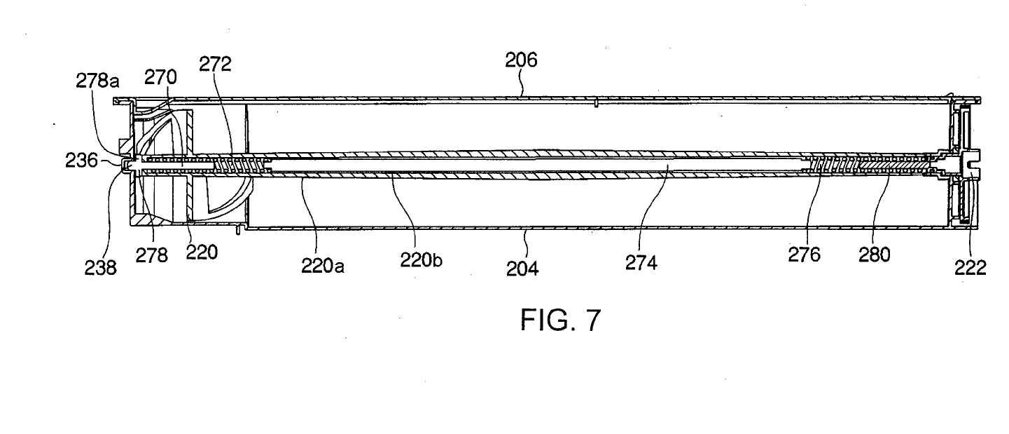

FIG. 7 is a cross sectional view of the mixer 220 for which a further advice is made. A shaft member 278 includes the shaft end 238 on the front side of a flange 278a and a spacer shaft 270 on the rear side of the flange 278a. The front end of the mixer 220 has a hole in the direction of the rotary shaft line. The hole is smaller than the diameter of the space 220b, so that there is a step part between the hole and the space in the spacer shaft 270.

The spacer shaft 270 is inserted into the hole. In the space 220b, the spacer shaft 270 is enclosed by a front spring 272. The end of the spacer shaft 270 is in contact with the front spring 272. The front spring 272 expands and contracts along the spacer shaft 270 in the direction of the rotary shaft line of the mixer 220. The front end of the front spring 272 is pressurized to the step part between the hole and the space 220b.

A clicker piece 274 is a rod which is narrower than the diameter of the space 220b and is longer than the diameter of the space 220b in the direction of the rotary shaft line of the mixer 220. In the clicker piece 274, the front end and rear end are smaller than the diameter of the central part, so that the step part is formed. The rear end of the front spring 272 encloses the front end of the clicker piece 274 and is pressurized to the step part of the front end. The front end of a rear spring 276 encloses the rear end of the clicker piece 274 and is pressurized to the step part of the rear end.

A spacer shaft 280 is extended from the mixer gear 222 toward the front side in the direction of the rotary shaft line of the mixer 220. The rear end of the spacer shaft 280 forms a step part between the connection portion to the mixer 220 of the mixer gear 222 and the rear end.

In the space 220b, the spacer shaft 280 is enclosed by the rear spring 276. The rear spring 276 expands and contracts along the spacer shaft 280 in the direction of the rotary shaft line of the mixer 220. The rear end of the rear spring 276 is pressurized to the step part between the rear end of the spacer shaft 280 and the connection portion to the mixer 220 of the mixer gear 222. The front spring 272 and rear spring 276 stretch between both ends of the space 220b and the spacer shaft 280 to prevent the clicker piece 274 from moving, so that unless the user shakes the toner cartridge 200 in the direction of the rotary shaft line of the mixer 220 with sufficient amplitude and power, the clicker piece 274 does not collide with the spacer shaft 270 and spacer shaft 280, thus no sound is produced.

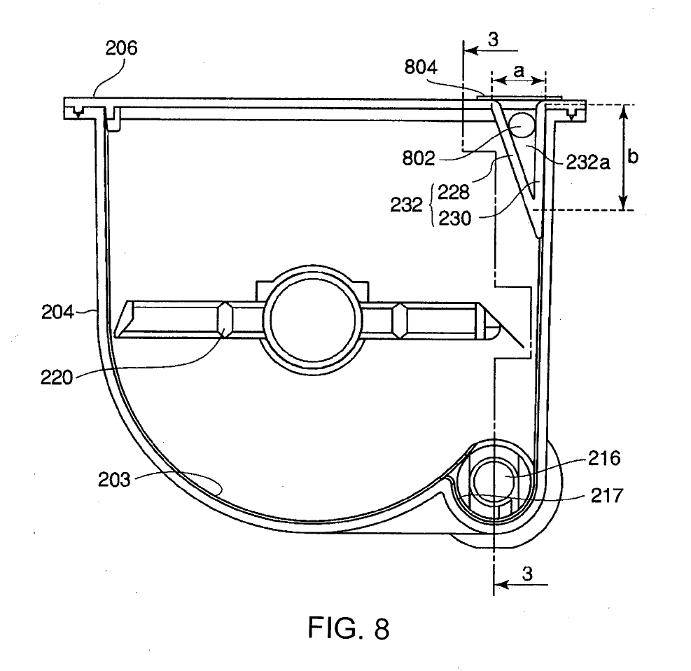

FIG. 8 is a cross sectional view of the toner cartridge 200 along the section 2-2 shown in FIG. 3. The lid 206 has the locator rib 232. The locator rib 232 includes a slope 228 having one end, viewed from the front side, at a width a in the width direction of the case 204 from the right wall of the case 204 and the other end at a height b down from the upper end of the right wall of the case 204 and a standing wall 230 at a height b down from the upper end of the right wall of the case along the right wall of the case 204. The surfaces of the slope 228 and standing wall 230 which face each other form a space in the locator rib 232. The space in the locator rib 232 has a length in the direction of the rotary shaft line of the mixer 220.

FIG. 8 shows also a modification. A clicker piece 802 is installed in a space 232a in the locator rib 232. A seal 804, to hold the clicker piece 802 in the space 232a, closes the opening of the space 232a. The clicker piece 802 is kept in the space 232a. The clicker piece 802 can move inside the space 232a. For the space 232a and clicker piece 802, advices such as the ones for the space 232b and clicker piece 202 shown in FIGS. 5 to 7 may be made.

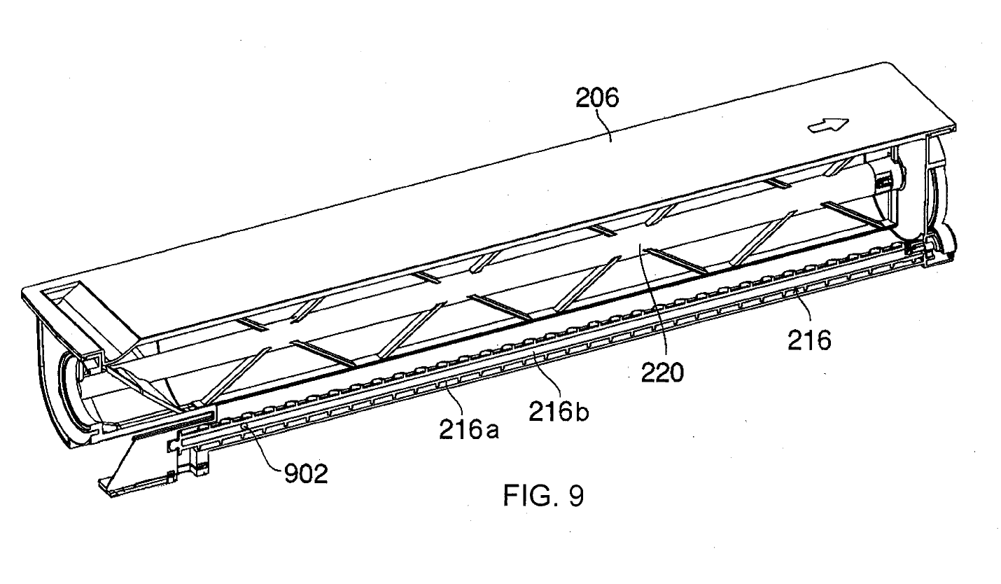

FIG. 9 shows an example that a modification of the screw 216 is drawn in the cross sectional view of the toner cartridge 200 along the section 202 shown in FIG. 8. The screw 216 has a hollow shaft 216a. A space 216b in the shaft may have a uniform diameter from the front end to the rear end. The space 216b ends at the front end. The space 216b is closed when the rear end is connected to the coupling 218. The space 216b may be increased gradually in diameter from one end to the other end so as to facilitate the die cutting for molding the mixer 220.

A clicker piece 802 is arranged in the space 216b. The clicker piece 902 can move inside the space 216b in the direction of the rotary shaft line of the screw 216. For the space 216b and clicker piece 902, advices such as the ones for the space 220b and clicker piece 202 shown in FIGS. 5 to 7 may be made.

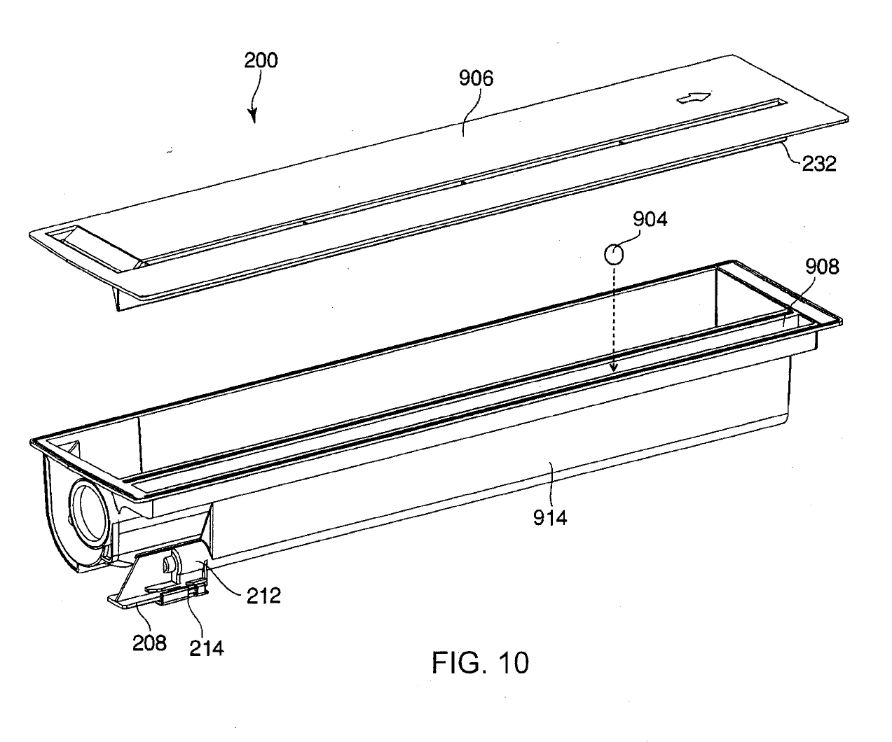

FIG. 10 is an exploded perspective view of a modification of the toner cartridge 200. The toner cartridge 200 has a gutter 908 opening on the top of a case 914. The top of the case 914 is closed by a lid 906. A clicker piece 904 is arranged in the gutter 908. The clicker piece 904 can move inside the gutter 908 in the direction of the rotary shaft line of the screw 216. For the space and clicker piece 902 which are shut in the gutter 908, advices such as the ones for the space 220b and clicker piece 202 shown in FIGS. 5 to 7 may be made. The gutter 908 is not always parallel with the direction of the rotary shaft line of the screw 216. The gutter 908 can desirably permit the displacement of the screw 216 in the direction of the rotary shaft line for the clicker piece 904, thus a direction crossing the direction of the rotary shaft line of the screw 216 instead of perpendicular is acceptable.

Sufficient amplitude and power to shake the toner cartridge can be indicated mechanically. Furthermore, the user can shake the toner cartridge with sufficient amplitude and power to break down toner.

What is claimed is:

1. A toner cartridge comprising:
a case to contain toner;
a rotator to rotate and stir the toner in the case round a rotary shaft line; and
a clicker piece to move a space separated from the toner in a direction of the rotary shaft line.

2. The cartridge according to claim 1, wherein the clicker piece is a sphere.

3. The cartridge according to claim 1, wherein the clicker piece is a rod.

4. The cartridge according to claim 1, wherein the rotator has a hollow shaft to permit the clicker piece to pass through in the direction of the rotary shaft line.

5. The cartridge according to claim 4, wherein a half of a total length of the shaft at maximum is hollow as the space.

6. The cartridge according to claim 4, wherein the clicker piece is narrower than a diameter of the space in the shaft and is longer than the diameter in the direction of the rotary shaft line.

7. The cartridge according to claim 1, wherein there is a spring in contact with an end of the clicker piece in the direction of the rotary shaft line.

8. The cartridge according to claim 1, wherein there is a spring stretching between the ends of the clicker piece and space.

9. The cartridge according to claim 8, wherein the end of the clicker piece is smaller than a diameter of a central part of the clicker piece, causing a step part.

10. The cartridge according to claim 9, wherein an end of the spring is pressurized to the step part of the clicker piece.

11. The cartridge according to claim 1, wherein there are a plurality of springs respectively in contact with both ends of the clicker piece in the direction of the rotary shaft line.

12. The cartridge according to claim 1, wherein there are a plurality of springs stretching respectively between both ends of the clicker piece and the space.

13. The cartridge according to claim 1, wherein separately from the rotator, there is a screw to convey the toner in the case in the direction of the rotary shaft line.

14. The cartridge according to claim 1, wherein there is a mixer rotating in an opposite direction to the rotator round a rotary shaft line parallel with the rotary shaft line.

15. The cartridge according to claim 1, wherein there are a rib in contact with the case having internally a space to permit the clicker piece to pass through in the direction of the rotary shaft line and a lid to close the case.

16. An image forming apparatus comprising:
a toner cartridge including:
a case to contain toner;
a rotator to rotate and stir the toner in the case round a rotary shaft line; and
a clicker piece to move a space separated from the toner in a direction of the rotary shaft line; and
an image forming unit to form an image on a sheet with the toner supplied by the toner cartridge.

17. The apparatus according to claim 16, wherein the clicker piece is a sphere.

18. The apparatus according to claim 16, wherein the clicker piece is a rod.

19. The apparatus according to claim 16, wherein the rotator has a hollow shaft to permit the clicker piece to pass through in the direction of the rotary shaft line.

20. The apparatus according to claim 19, wherein a half of a total length of the shaft at maximum is hollow as the space.
